(19) United States
(12) Patent Application Publication
(10) Pub. No.: US 2026/0338216 A1
(43) Pub. Date: Oct. 29, 2026

(54) Adjustable Fastener Assembly

(71) Applicant: Illinois Tool Works Inc., Glenview, IL (US)

(72) Inventor: Darren James Zellak, Lisle, IL (US)

(21) Appl. No.: 19/640,625

(22) Filed: Apr. 7, 2026

Related U.S. Application Data
(60) Provisional application No. 63/794,896, filed on Apr. 25, 2025.

(51) Int. Cl. F16B 21/08; F16B 2/22; F16L 3/12; F16L 3/237

(52) U.S. Cl. CPC F16B 21/082; F16B 2/22; F16B 21/086; F16L 3/1211; F16L 3/1222; F16L 3/237

(57) ABSTRACT

Described is an adjustable fastener assembly for attaching a first component to a second component. The adjustable fastener assembly includes a carrier component, and a fastener insert. The carrier component defines a fastener track. The carrier component is able to retain the first component. The fastener insert has a first attachment end to engage the carrier component and a second attachment end to engage the second component. The first attachment end is configured to secure the carrier component slidably via the fastener track.

### RELATED APPLICATION

The present application claims priority to United States Provisional Patent Application No. 63/794,896, filed Apr. 25, 2025, and entitled “Adjustable Fastener Assembly,” which is hereby incorporated by reference in its entirety.

### BACKGROUND

Vehicular components, such as those used in automotive applications, require attachment and fastening solutions that are both simple to manufacture and easy to assemble. In many cases, objects must be securely fastened to the vehicle to prevent unwanted movement or shifting during operation, which can lead to damage, kinking, or rattling. For instance, tubes, hoses, wires, and other conduits are commonly secured to vehicle structures using a retainer assembly.

Above all, fastening techniques must be reliable and efficient. In some implementations, a retainer assembly or other form of fastener assembly may be mounted to the vehicle via an opening in a panel. Traditionally, once installed, these assemblies restrict movement in all directions. However, in certain scenarios, allowing limited movement in a particular direction can help accommodate alignment variations during installation or operation.

Accordingly, there remains a need for an improved fastener assembly that enables controlled linear movement relative to the panel opening, enhancing flexibility and ease of alignment without compromising secure attachment.

### SUMMARY

The present disclosure relates generally to a fastening system to form a connection between two components using an adjustable fastener assembly, substantially as illustrated by and described in connection with at least one of the figures, as set forth more completely in the claims. In an example, the adjustable fastener assembly allows for controlled linear movement relative to the panel opening.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a through 1c illustrate a fastening system configured to secure one or more first components relative to a second component having an opening formed therein via an adjustable fastener assembly in accordance with an aspect of this disclosure.

FIG. 2 a illustrates the adjustable fastener assembly of FIGS. 1a through 1c in an open position to facilitate loading of one or more first components into its respective pocket.

FIG. 2b illustrates an underside isometric view of the adjustable fastener assembly.

FIG. 2c illustrates an underside plan view of the adjustable fastener assembly.

FIG. 2d illustrates a cross-sectional topside isometric view of the adjustable fastener assembly taken along cut-line A-A (FIG. 1c).

FIG. 2e illustrates a cross-sectional side elevation view of the adjustable fastener assembly taken along cut-line A-A (FIG. 1c).

FIG. 3a illustrates an underside isometric view of a fastener insert for the adjustable fastener assembly in accordance with an aspect of this disclosure.

FIG. 3b illustrates a topside isometric view of the fastener insert.

FIG. 3c illustrates a top plan view of the fastener insert.

FIG. 3d illustrates a bottom plan view of the fastener insert.

FIGS. 3e, 3f, 3g, and 3h illustrate, respectively, first, second, third, and fourth side elevation views of the fastener insert.

FIG. 4a illustrates an isometric view of a carrier component of an adjustable fastener assembly in accordance with another aspect of this disclosure.

FIG. 4b illustrates an underside plan view of the carrier component of FIG. 4a.

FIG. 4c illustrates a first cross-sectional isometric view of the carrier component taken along cut-line B-B (FIG. 4a).

FIG. 4d illustrates a second cross-sectional isometric view of the carrier component taken along cut-line C-C (FIG. 4a).

FIG. 4e illustrates a side elevation view of the carrier component.

FIG. 4f illustrates a bottom plan view of the carrier component.

FIG. 4g illustrates an isometric assembly view of the carrier component with a fastener insert.

FIG. 4h illustrates an isometric assembled view of the adjustable fastener assembly.

FIG. 4i illustrates a first cross-sectional isometric view of the adjustable fastener assembly taken along cut-line D-D (FIG. 4h).

FIG. 4j illustrates a second cross-sectional isometric view of the adjustable fastener assembly taken along cut-line E-E (FIG. 4h).

FIGS. 5a through 5g illustrate additional styles of fastener inserts suitable for coupling the carrier component with the component in accordance with other aspects of this disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

An adjustable fastener assembly can be used to couple a first component to a second component, while allowing for controlled linear movement of the first component relative to an opening in the second component upon installation.

In one example, an adjustable fastener assembly for attaching a first component to a second component comprises: a carrier component comprising a fastener track, wherein the carrier component being configured to retain the first component; and a fastener insert having a first attachment end configured to engage the carrier component and a second attachment end configured to engage the second component, wherein the first attachment end is configured to secure the carrier component slidably via the fastener track.

In some examples, the first attachment end and the second attachment end are oriented in opposed directions.

In some examples, the fastener track comprises a channel flanked by a pair of ledges. The pair of ledges can be configured to secure a portion of the first attachment end in the channel and the portion of the first attachment end is configured to slide linearly in the channel.

In some examples, the first attachment end comprises a pair of legs spaced-apart relative to one another and resiliently connected to a base structure. The pair of legs can be parallel to one another. The pair of legs can be configured to flex inwardly toward one another during insertion into the fastener track. The pair of legs can be configured to spring back once fully inserted into the fastener track. Each of the pair of legs can comprise a flexible portion with a snap fitting positioned at a free end of the flexible portion.

In some examples, the second attachment end is configured to engage an opening formed in the second component. The second attachment end can comprise a body structure that defines a central longitudinal axis and comprises a plurality of component-retention features resiliently coupled to or within an exterior surface of the body structure.

In some examples, the second attachment end comprises a plurality of component-retention features.

In some examples, the plurality of component-retention features comprises one or more legs arranged as a clip assembly. The clip assembly can be a “W-type” clip assembly.

In some examples, the plurality of component-retention features comprises a plurality of fins arranged as a push-pin assembly.

In some examples, the plurality of component-retention features comprises a plurality of box-prong legs arranged as a box-prong assembly.

In some examples, the first component is a tube, and the carrier component comprises a pocket configured to retain the tube. For example, the carrier component comprises a carrier base and a lid coupled to the carrier base via a hinge, wherein the lid is configured to secure the tube in the pocket. In some examples, the carrier base, the lid, and the hinge are a unitary structure.

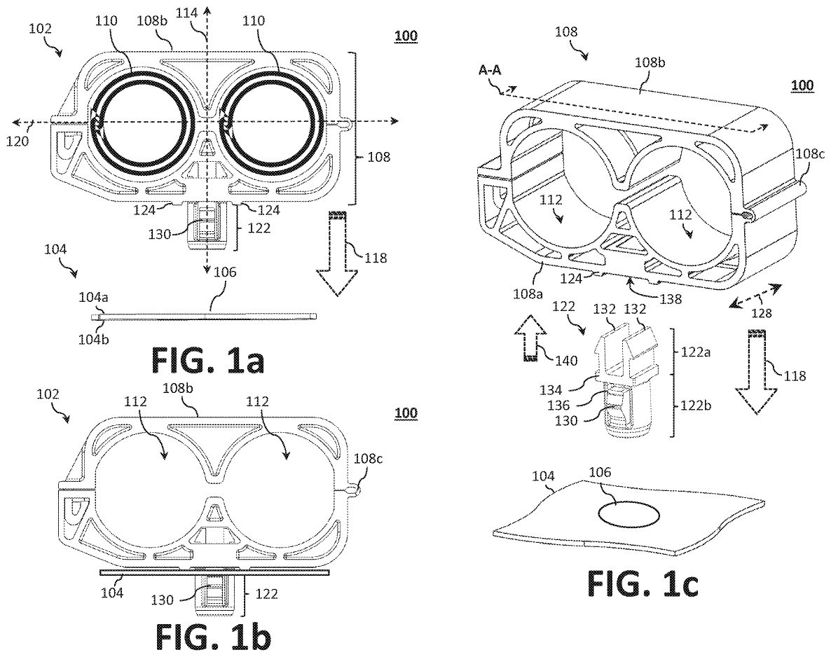

FIGS. 1a through 1c illustrate a fastening system 100 configured to secure one or more first components 110 relative to a second component 104 having an opening 106 formed therein via an adjustable fastener assembly 102 in accordance with an aspect of this disclosure.

The one or more first components 110 may be, for example, brake lines, fuel lines, wires, cables (e.g., electric cables), pipes, and/or any other tubular structure that may be secured to a second component 104. In the illustrated example, the adjustable fastener assembly 102 is configured to retain two first components 110 of like diameter. While the adjustable fastener assembly 102 will be described primarily as an assembly configured to attach tubes, the teachings of the subject disclosure can be used to attach a plethora of other objects and components relative to the second component 104 where linear movement is desired.

In the illustrated example, the second component 104 defines an A-side surface 104a (e.g., a first surface, such as an exterior surface) and a B-side surface 104b (e.g., a second surface, such as an interior surface). The one or more first components 110 are illustrated as being secured to or on the A-side surface 104a. The second component 104 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

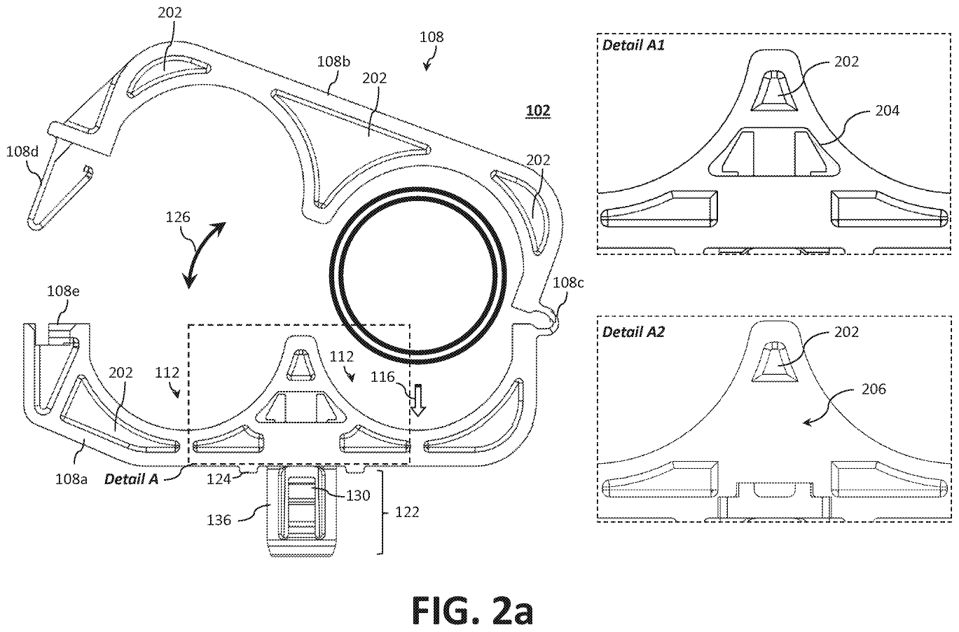

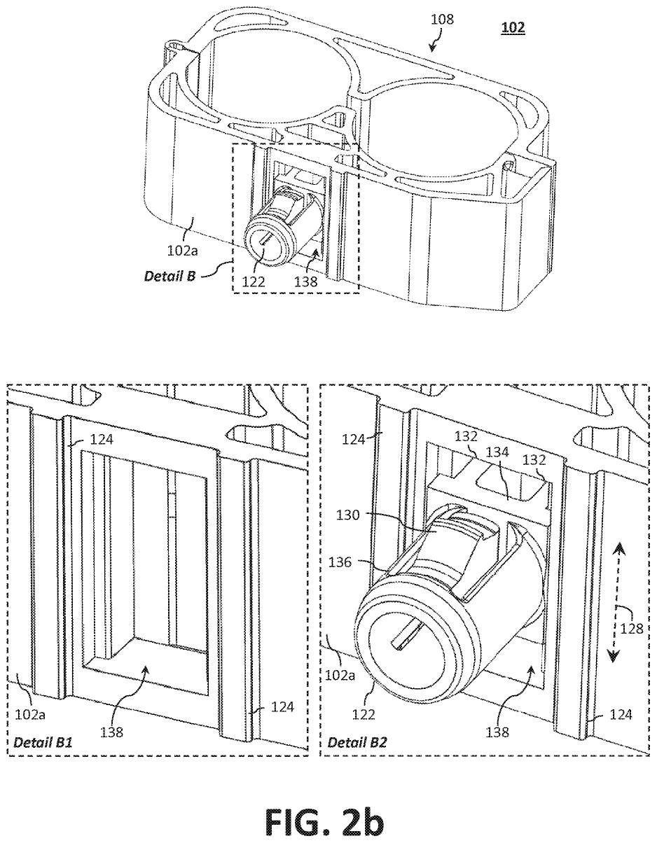

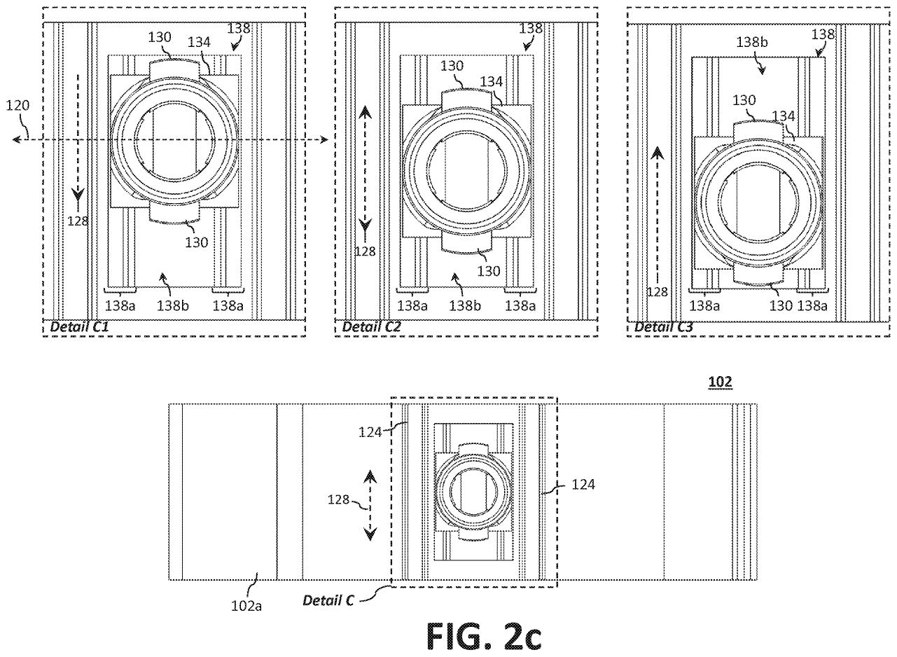

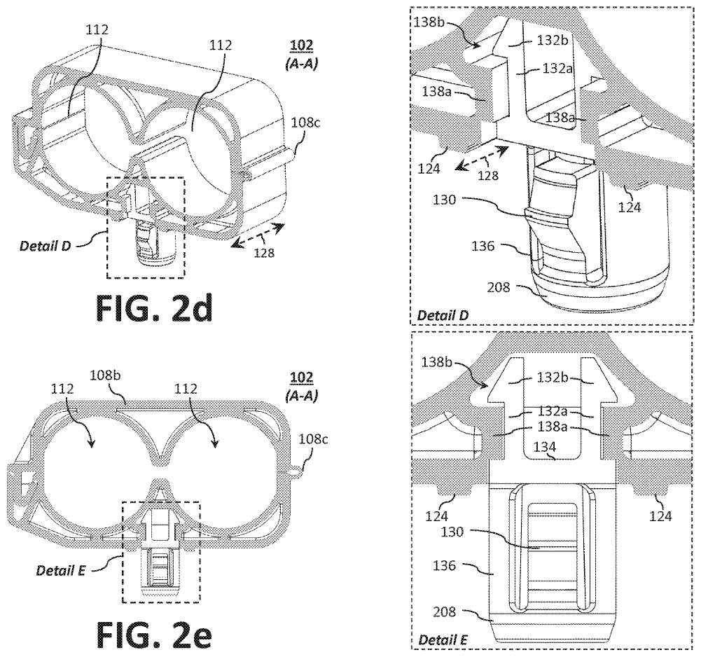

FIG. 2 a illustrates the adjustable fastener assembly 102 of FIGS. 1a through 1c in an open position to facilitate loading of one or more first components 110 into its respective pocket 112. FIGS. 2b and 2c illustrate, respectively, underside isometric and plan views of the adjustable fastener assembly 102. FIG. 2d illustrates a cross-sectional topside isometric view of the adjustable fastener assembly 102 taken along cut-line A-A (FIG. 1c), while FIG. 2e illustrates a cross-sectional side elevation view of the adjustable fastener assembly 102 taken along cut-line A-A (FIG. 1c).

The adjustable fastener assembly 102 may include, define, or otherwise provide a carrier component 108 and a fastener insert 122. The fastener insert 122 is configured to be removeably coupled with the carrier component 108 and to slide relative to the carrier component 108 along an axis (e.g., a slide axis 128). As illustrated, when assembled, the fastener insert 122 is generally perpendicular to the carrier component 108 such that a central longitudinal axis 114 runs down the center of the fastener insert 122 is generally perpendicular to a horizontal axis 120 that runs along the width of the carrier component 108. In the illustrated example, the fastener insert 122 is configured to be coupled with a fastener track 138 that is formed or otherwise defined by the carrier component 108. As will be described, the fastener track 138 generally comprises a channel 138b flanked on each side along the length by a pair of ledges 138a.

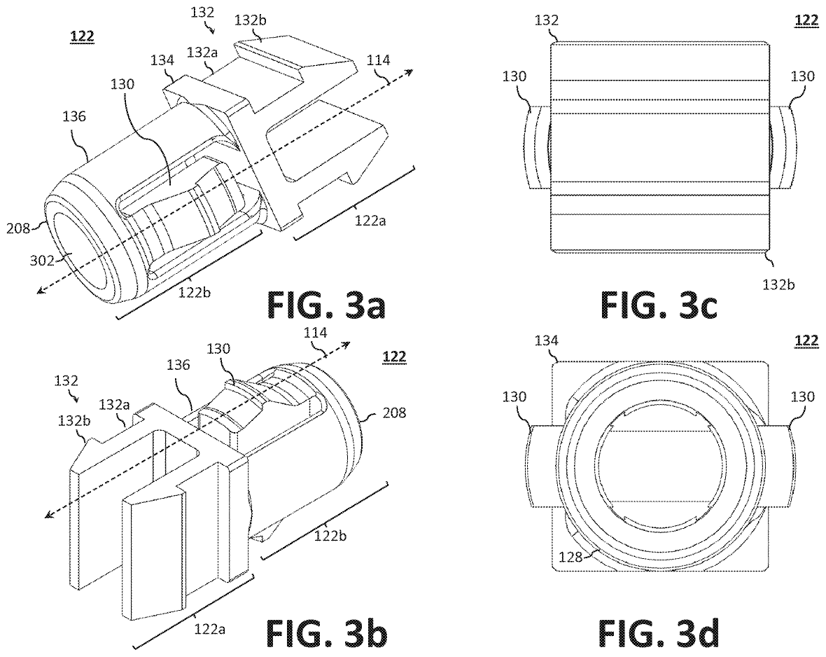

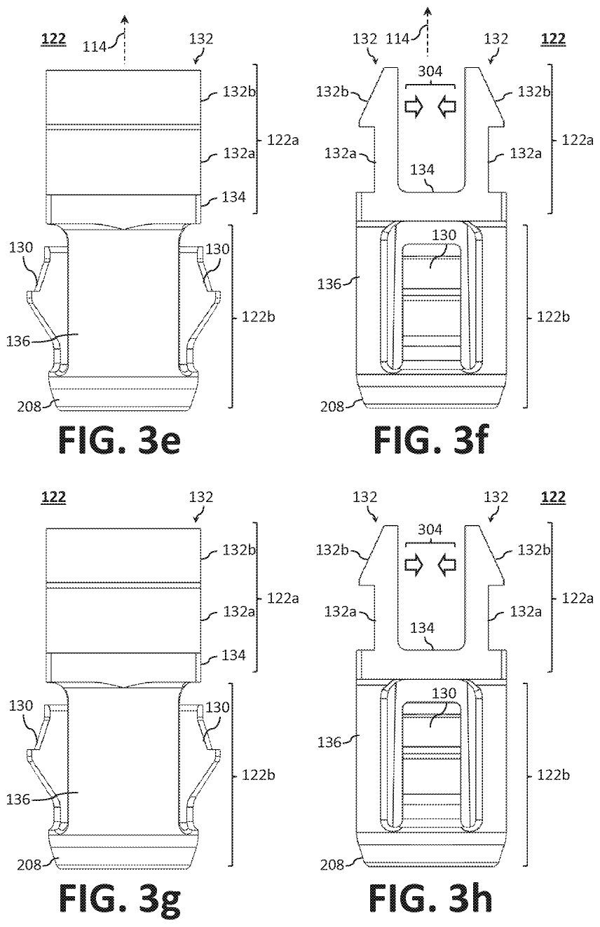

FIG. 3a illustrates an underside isometric view of a fastener insert 122 for the adjustable fastener assembly 102 in accordance with an aspect of this disclosure. FIG. 3b illustrates a topside isometric view of the fastener insert 122. FIGS. 3c and 3d illustrate, respectively, top, and bottom plan views of the fastener insert 122. FIGS. 3e and 3h illustrate, respectively, first, second, third, and fourth side elevation views of the fastener insert 122.

The carrier component 108 is configured to couple with and/or secure one or more first components 110 (illustrated as tubes) relative to one another and, ultimately, the second component 104. For example, the carrier component 108 is illustrated with a carrier base 108a that defines a plurality of pockets 112, each of which is configured to secure a first component 110. As illustrated, each of the plurality of pockets 112 can be shaped as a cylindrical channel with an inner diameter that generally corresponds to an outer diameter of the first components 110.

In some examples, the carrier component 108 may include a lid 108b to secure the one or more first components 110 within one or more of the plurality of pockets 112. As best illustrated in FIG. 1g, the lid 108b can be pivoted relative to the carrier base 108a about a hinge 108c between an open position (FIG. 2 a) and the closed position (FIGS. 1a through 1c) as indicated by arrow 126 to provide access to the plurality of pockets 112 during installation of the one or more first components 110. When in the open position, a first component 110 can be inserted into each of the plurality of pockets 112 by urging the first component 110 toward the respective tube pocket 112 in the direction indicated by arrow 116. Once the one or more first components 110 are inserted, the lid 108b can be pivoted about the hinge 108c to the closed position. In the illustrated example, a snap 108d is provided at a free end of the lid 108b (e.g., opposite the hinge 108c) that is configured to engage a corresponding feature 108e of the carrier component 108, such as a ledge, edge, or other protrusion. In lieu of the lid 108b, the plurality of pockets 112 may be shaped to secure the one or more first components 110 via an interference fit (e.g., via features positioned at the opening to the plurality of pockets 112, such as ledges, bumps, etc.). While two pockets 112 are illustrated, additional or fewer pockets 112 may be provided depending on the design needs (e.g., the number of first components 110 that need to be secured).

The fastener insert 122 of the illustrated adjustable fastener assembly 102 serves to couple the carrier component 108 to the second component 104, while permitted linear movement of the carrier component 108 relative to the second component 104. A benefit of the described adjustable fastener assembly 102 is that it can be shifted to ensure alignment via the fastener insert 122.

To that end, the fastener insert 122 is a double-ended fastener insert that includes a first attachment end 122a configured to engage the carrier component 108 (e.g., via the fastener track 138) and a second attachment end 122b configured to engage the opening 106 in the second component 104. The first attachment end 122a and the second attachment end 122b are oriented in opposed directions. In the illustrated example, the first attachment end 122a comprises a pair of spaced-apart legs 132 resiliently connected to a base structure 134. The pair of legs 132 are illustrated as parallel to one another and configured to flex inwardly toward one another and the central longitudinal axis 114 as indicated by the arrows 304 (FIG. 3f) during insertion into the fastener track 138. As each of the pair of legs 132 generally comprise a flexible portion 132a with a snap fitting 132b (e.g., a button, ledge, or the like) positioned at the free end (i.e., the end of the flexible portion 132a opposite the end of the flexible portion 132a that is coupled to the base structure 134. In the illustrated example, the snap fittings 132b are each oriented to face away from the central longitudinal axis 114. While the pair of legs 132 are illustrated and described as flexing inwardly toward one another, other arrangements are contemplated, including configurations where the first attachment end 122a comprises outwardly-flexing legs.

As illustrated in, for example, FIG. 2d (Detail D) and 2e (Detail E), the fastener track 138 comprises a channel 138b flanked by a pair of ledges 138a. In this example, the first attachment end 122a comprises a pair of legs 132 spaced-apart relative to one another and resiliently connected to a base structure 134, each leg 132 having a snap fitting 132b positioned at a free end of the flexible portion 132a. When assembled, the snap fittings 132b snap into the channel 138b. For example, the pair of legs 132 are configured to flex inwardly toward one another during insertion into the fastener track 138 such that the snap fitting 132b can pass the pair of ledges 138a to access the channel 138b. The pair of legs 132 are configured to spring back once fully inserted into the channel 138b (in the direction of arrow 140) of the fastener track 138.

With reference to FIG. 2b, Detail B1 illustrates the fastener track 138 with the fastener insert 122 removed, while Detail B2 illustrates the fastener track 138 with the fastener insert 122 inserted. The pair of ledges 138a are configured to secure a portion of the first attachment end 122a in the channel 138b and the portion of the first attachment end 122a is configured to slide linearly in the channel 138b. For example, Details C1, C2, and C3 of FIG. 2c illustrate the fastener insert 122 sliding linearly along the slide axis 128 via the channel 138b between a first extreme position (Detail C1) and a second extreme position (Detail C3) via an intermediate position (Detail C2). In some embodiments, the channel 138b may include a ratchet or other retention feature to selectively secure the fastener insert 122 at one or more positions along the slide axis 128. For example, a series of ridges, bumps, detents, or similar features may be formed along one or more surfaces of the channel 138b to engage with the fastener insert 122 and allow it to snap into a desired position. Additionally, the fastener insert 122 may be locked in place using mechanisms such as a latch, pawl, adhesive, or channel inserts (e.g., components positioned within the channel 138b to obstruct and prevent further linear movement of the fastener insert 122).

The illustrated second attachment end 122b comprises a body structure 136 having a pair of component-retention features 130 resiliently connected to the body structure 136. The body structure 136 is illustrated as a cylindrical body structure, though other shapes are contemplated. As illustrated, the component-retention features 130 extend outwardly away from the central longitudinal axis 114 to engage the opening 106. In some examples, the leading end 208 of the body structure 136 is rounded or chamfered to assist alignment during insertion into the opening 106.

As best illustrated in FIGS. 1a through 1c, the second component 104 includes, defines, or otherwise provides the opening 106, which may be formed during manufacturing of the second component 104. During installation, the second attachment end 122b of the fastener insert 122 of the adjustable fastener assembly 102 is inserted into the opening 106 formed in or on a surface of the second component 104 as indicated by the arrow 118 such that the component-retention features 130 engage the opening 106 (e.g., the perimeter of the second component 104 that defines the opening). In some examples, the adjustable fastener assembly 102 may comprise a seal when desirable to mitigate dust, dirt, and/or moisture penetration through the opening 106. The seal may be embodied as a ring (e.g., an annulus) and fabricate from foam material, thermoplastic, rubber, etc. For example, a seal can be configured to fit over the distal end of the adjustable fastener assembly 102 to surround a portion of the fastener insert 122 (e.g., the shank). The adjustable fastener assembly 102 may include additional features, such as ribs and wings to mitigate noise and/or rattle between the adjustable fastener assembly 102 and the second component 104. For example, the carrier component 108 may include a pair of standoffs 124 formed on the carrier base 108a at opposite sides of the fastener track 138. The pair of standoffs 124 serves to provide a distance between the second component 104 and the carrier component 108, thus mitigating buzz, squeak, and rattle (BSR).

Each of the carrier component 108 and the fastener insert 122 may be formed as a unitary structure that are subsequently coupled to form the multi-component adjustable fastener assembly 102.

In one example, components of the adjustable fastener assembly 102 can be fabricated via mold tooling and a plastic-injection molding process. While the adjustable fastener assembly 102 is shown as a multi-component structure, the fastener assembly 102 may alternatively be injection-molded as a single, unified piece using flash gating-a technique that allows material to flow through thin, wide channels to form complex parts in one mold. In another example, the adjustable fastener assembly 102 (or a portion thereof) can be fabricated using metal via, for example, metal-stamping and/or cold-forming processes. In yet another example, the components of the adjustable fastener assembly 102 can be printed thermoplastic material components that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the adjustable fastener assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (um). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., the higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the adjustable fastener assembly 102 may be formed or otherwise fabricated at different resolutions during a printing operation. For example, the carrier component 108 (or portions thereof) may be printed at a lower resolution than that of the fastener insert 122 or vice versa as needed for a particular application.

As described above, the adjustable fastener assembly 102 is configured to receive one or more first components 110 via the carrier component 108 and to engage the second component 104 via the fastener insert 122 such that the carrier component 108 can translate relative to the opening 106 post assembly along the slide axis 128. In the illustrated examples, the slide axis 128 is shown as being perpendicular to the horizontal axis 120 of the carrier component 108. However, the slide axis 128 may be oriented at any angle relative to the horizontal axis 120 to achieve a desired linear movement. For instance, the slide axis 128 may be parallel to the horizontal axis 120 or positioned at any transverse angle between 0 and 90 degrees (e.g., approximately 45 degrees).

In some examples, the adjustable fastener assembly 102 comprises one or more windows 204 (e.g., recesses, cut outs, or openings) formed in or on the carrier component 108 and/or the fastener insert 122. The one or more windows 204 can serve to reduce the amount of material needed to fabricate the adjustable fastener assembly 102, thus reducing material cost and part weight. The carrier component 108 can also include one or more track windows 204 to enable to user to view or access the pair of legs 132 when assembly, as well as reducing material usages. For example, with reference to FIG. 2a at Detail A1, a tool can be inserted into the track windows 204 to manipulate (e.g., to push/bend) the pair of legs 132 and to disengage the pair of legs 132 from the fastener track 138, thereby releasing the fastener insert 122 from the carrier component 108. Additionally, or alternatively, one or both sides of the fastener track 138 can instead be closed off via a plate or wall structure 206, an example of which is illustrated in FIG. 2a at Detail A2. For example, where the wall structure 206 can be provided where additional rigidity is desired.

The illustrated second attachment end 122b generally comprises a body structure 136 that defines (or otherwise includes) a hollow space 302. The component-retention features 130 extend outwardly from the body structure 136 away from the central longitudinal axis 114 to engage the opening 106. The body structure 136 defines a leading end 208 configured to be inserted into an opening 106. The leading end 208 can be rounded, tapered, or otherwise shaped to increase insertion ease. For example, the leading end 208 of the body structure 136 can be chamfered along the outer perimeter to help align and guide the leading end 208 through the opening 106.

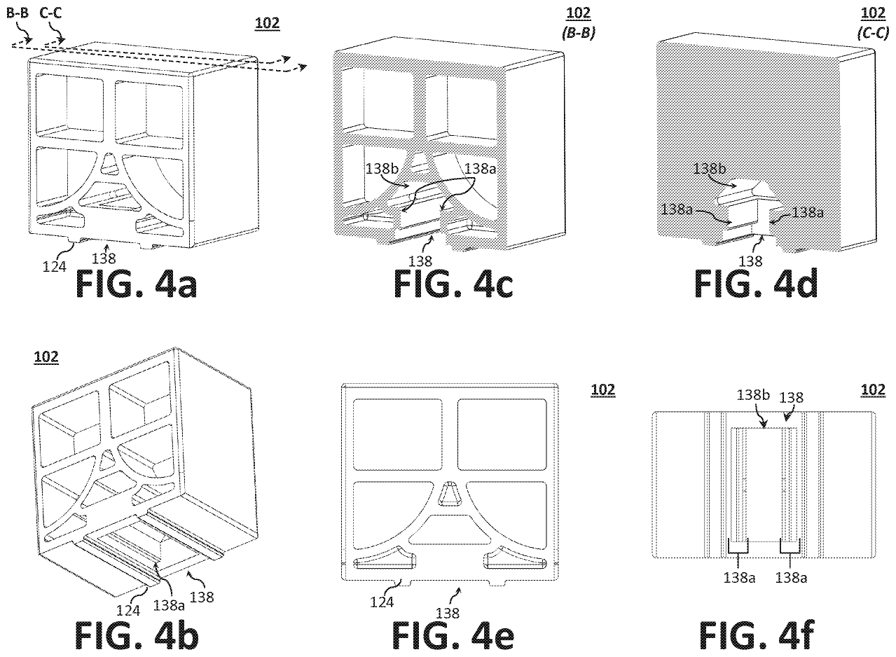

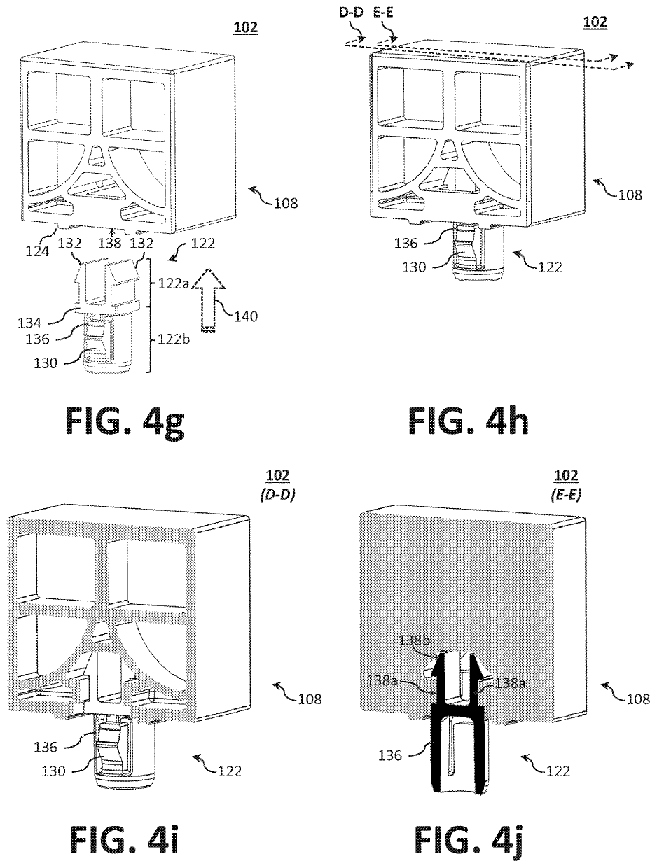

FIG. 4a illustrates an isometric view of a carrier component 108 of an adjustable fastener assembly 102 in accordance with another aspect of this disclosure. FIG. 4b illustrates an underside plan view of the carrier component 108 of FIG. 4a, while FIGS. 4c and 4d illustrate cross-sectional isometric views of the carrier component 108 taken along cut-line B-B (FIG. 4a) and cut-line C-C (FIG. 4a), respectively. FIGS. 4e and 4f illustrate, respectively, side elevation and bottom plan views of the carrier component 108. FIG. 4g illustrates an isometric assembly view of the carrier component 108 with a fastener insert 122, while FIG. 4h illustrates an isometric assembled view of the adjustable fastener assembly 102. FIGS. 4i and 4j illustrate cross-sectional isometric views of the adjustable fastener assembly 102 taken along cut-line D-D (FIG. 4h) and cut-line E-E (FIG. 4h), respectively.

The adjustable fastener assembly 102 of FIGS. 4a through 4j is substantially the same as the adjustable fastener assembly 102 of FIGS. 1a through 1c and FIGS. 2a through 2e except that the carrier component 108 is illustrated as a test block to represent that the slideable interface between the carrier component 108 and the fastener insert 122 can be applied to a variety of fastener component formats where it is desirable to allow the fastener component to slide or translate linearly relative to the second component 104. Therefore, while the carrier component 108 could be a tube retainer as disclosed FIGS. 1a through 1c and FIGS. 2a through 2e, the carrier component 108 would also be embodied as accessory hooks, D-Rings, cable ties (zip ties), pipe clamps etc.

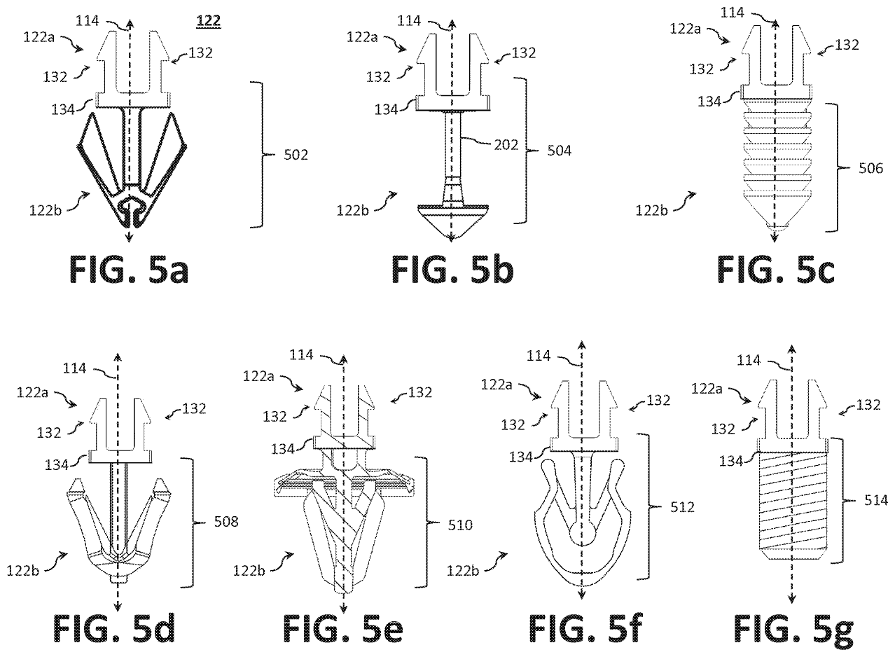

While the fastener insert 122 is illustrated in the figures as a cylindrical fastener with two prongs, other fastener designs are contemplated. For example, FIGS. 5a through 5g illustrate additional styles of fastener insert 122s suitable for coupling the carrier component 108 with the component in accordance with other aspects of this disclosure. Specifically, FIGS. 3a through 5g illustrate, respectively, a W-shaped clip fastener 502 (illustrated as a 2-legged clip fastener), pin fastener 504, a push-pin fastener 506 (illustrated as a 2-legged box-prong fastener), a specialty clip assembly 508 (e.g., a CenterLok™M fastener, which is available from Deltar®), a clip assembly with four retaining legs 510, an clip assembly with two snap-engaging seats 512, and a threaded shank 514 (e.g., a threaded stud). The clip assembly with four retaining legs 510, which is illustrated in FIG. 5e as a cross-sectional view, is further described in connection with commonly owned U.S. Pat. No. 10,385,901 to Jeffrey J. Steltz. The clip assembly with two snap-engaging seats 512 of FIG. 5f is further described in connection with commonly owned U.S. Pat. No. 10,018,214 to Fulvio Pacifico Yon. Other suitable fastening techniques that can be used as the second attachment end 122b include, for example, threaded fasteners, quarter turn fastener, etc.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. An adjustable fastener assembly for attaching a first component to a second component, the adjustable fastener assembly comprising:
a carrier component comprising a fastener track,
wherein the carrier component being configured to retain the first component; and
a fastener insert having a first attachment end configured to engage the carrier component and a second attachment end configured to engage the second component,
wherein the first attachment end is configured to secure the carrier component slidably via the fastener track.

2. The adjustable fastener assembly of claim 1, wherein the first attachment end and the second attachment end are oriented in opposed directions.

3. The adjustable fastener assembly of claim 1, wherein the fastener track comprises a channel flanked by a pair of ledges.

4. The adjustable fastener assembly of claim 3, wherein the pair of ledges are configured to secure a portion of the first attachment end in the channel and the portion of the first attachment end is configured to slide linearly in the channel.

5. The adjustable fastener assembly of claim 1, wherein the first attachment end comprises a pair of legs spaced-apart relative to one another and resiliently connected to a base structure.

6. The adjustable fastener assembly of claim 5, wherein the pair of legs are parallel to one another.

7. The adjustable fastener assembly of claim 5, wherein the pair of legs are configured to flex inwardly toward one another during insertion into the fastener track.

8. The adjustable fastener assembly of claim 7, wherein the pair of legs are configured to spring back once fully inserted into the fastener track.

9. The adjustable fastener assembly of claim 5, wherein each of the pair of legs comprises a flexible portion with a snap fitting positioned at a free end of the flexible portion.

10. The adjustable fastener assembly of claim 1, wherein the second attachment end is configured to engage an opening formed in the second component.

11. The adjustable fastener assembly of claim 10, wherein the second attachment end comprises a body structure that defines a central longitudinal axis and comprises a plurality of component-retention features resiliently coupled to or within an exterior surface of the body structure.

12. The adjustable fastener assembly of claim 10, wherein the second attachment end comprises a plurality of component-retention features.

13. The adjustable fastener assembly of claim 12, wherein the plurality of component-retention features comprises one or more legs arranged as a clip assembly.

14. The adjustable fastener assembly of claim 13, wherein the clip assembly is a “W-type” clip assembly.

15. The adjustable fastener assembly of claim 12, wherein the plurality of component-retention features comprises a plurality of fins arranged as a push-pin assembly.

16. The adjustable fastener assembly of claim 12, wherein the plurality of component-retention features comprises a plurality of box-prong legs arranged as a box-prong assembly.

17. The adjustable fastener assembly of claim 1, wherein the first component is a tube, and the carrier component comprises a pocket configured to retain the tube.

18. The adjustable fastener assembly of claim 17, wherein the carrier component comprises a carrier base and a lid coupled to the carrier base via a hinge, wherein the lid is configured to secure the tube in the pocket.

19. The adjustable fastener assembly of claim 18, wherein the carrier base, the lid, and the hinge are a unitary structure.
